(19) United States
(12) Patent Application Publication
(10) Pub. No.: US 2018/0089778 A1
(43) Pub. Date: Mar. 29, 2018

(54) CONTRACT ASSISTANCE APPARATUS, CONTRACT ASSISTANCE SYSTEM, AND CONTRACT ASSISTANCE METHOD

(71) Applicant: PANASONIC INTELLECTUAL PROPERTY MANAGEMENT CO., LTD., Osaka (JP)

(72) Inventor: Norio MIYAZAKI, Kanagawa (JP)

(21) Appl. No.: 15/563,534

(22) PCT Filed: Mar. 16, 2016
(86) PCT No.: PCT/JP2016/001494

§ 371 Date: Sep. 29, 2017

(30) Foreign Application Priority Data
Mar. 31, 2015 (JP) 2015-073135

(51) Int. Cl. G06Q 50/18; G06Q 50/06; G06Q 30/06; H02J 3/00

(52) U.S. Cl. CPC G06Q 50/188; H02J 3/008; G06Q 30/0619; G06Q 50/06

(57) ABSTRACT

A contract assistance apparatus of the present invention includes a service information acquirer, a result information acquirer, an information extractor, a generator, and an outputter. The information extractor extracts, from a plurality of service plans to be provided to a consumer of electric power, a service plan which leads to maximum remuneration for the consumer on the basis of result information regarding power consumption in a target space to which electric power is supplied. The generator uses the service plan extracted by the information extractor to generate recommendation information to be provided to the consumer. The outputter outputs the recommendation information generated by the generator.

### TECHNICAL FIELD

The present invention generally relates to contract assistance apparatuses, contract assistance systems, and contract assistance methods. The present invention specifically relates to a contract assistance apparatus configured to assist in selecting one of service plans shown to a consumer of electric power, a contract assistance system including the contract assistance apparatus, and a contract assistance method used by the contract assistance apparatus.

### BACKGROUND ART

Business of adjusting an electric power demand, assisting in saving electric power, and the like by managing electric power in consumers has been proposed (see, for example, Patent Literature 1). To conduct such business, a business operator has to contract with a plurality of consumers. The business operator which conducts such business is referred to as an aggregator. Patent Literature 1 describes a technique in which when a power management business operator receives a power saving request, the power management business operator transmits power saving response information of each of consumers to a power management terminal of a corresponding one of the consumers. Patent Literature 1 also describes that cooperation money (remuneration) is paid when the consumers generate negawatt power in response to the power saving request.

Moreover, a technique has been proposed in which it is determined whether or not an electricity price is reduced by shifting a time zone for use of a high-power-consumption appliance of a plurality of appliances, and if the electricity price is reduced, the shifted time zone is recommended (see Patent Literature 2).

Patent Literature 1 describes that the aggregator which manages the electric power of the consumers pays cooperation money (remuneration) for consumers' act of saving electric power. However, Patent Literature 1 fails to describe a technique for increasing the remuneration to be paid for the saving of electric power by the consumers.

Moreover, Patent Literature 2 describes a technique for assisting a contractee (consumer) with a reduction in an electricity price but fails to describe a technique for increasing remuneration for saving of electric power by the contractee (consumer).

### CITATION LIST

### Patent Literature

Patent Literature 1: JP 2013-230051 A

Patent Literature 2: JP 2011-258020 A

### SUMMARY OF INVENTION

It is an object of the present invention to provide a contract assistance apparatus configured to assist with a contract between a consumer and a business operator to increase remuneration obtained when the consumer saves electric power. It is another object of the present invention to provide a contract assistance system including the contract assistance apparatus and a contract assistance method used by the contract assistance apparatus.

A contract assistance apparatus according to an aspect of the present invention includes a service information acquirer, a result information acquirer, an information extractor, a generator, and an outputter. The service information acquirer is configured to acquire a plurality of service plans to be provided to a consumer who consumes electric power. The result information acquirer is configured to acquire result information regarding electric power consumption in a target space to which electric power is supplied. The information extractor is configured to extract, from the plurality of service plans, a service plan to be recommended to the consumer based on the result information. The generator is configured to use the service plan extracted by the information extractor to generate recommendation information to be provided to the consumer. The outputter is configured to output the recommendation information generated by the generator. The plurality of service plans include remuneration information regarding remuneration to be received by the consumer when the consumer reduces an amount of received electric power in the target space from an electric power grid. The information extractor extracts, from the plurality of service plans, a service plan which leads to maximum remuneration for the consumer.

A contract assistance system according to an aspect of the present invention includes the contract assistance apparatus and a management apparatus. The management apparatus is configured to communicate with the contract assistance apparatus and to transfer the result information regarding electric power consumption in the target space to the contract assistance apparatus.

A contract assistance method according to an aspect of the present invention includes selecting, from a plurality of service plans to be provided to a consumer of electric power, a service plan to be recommended to the consumer by an information extractor based on result information regarding power consumption in a target space to which electric power is supplied. The contract assistance method includes generating by using the service plan selected by the information extractor, recommendation information to be provided to the consumer by a generator. The plurality of service plans include remuneration information regarding remuneration to be received by the consumer when the consumer reduces an amount of received power in the target space from an electric power grid. The information extractor extracts, from the plurality of service plans, a service plan which leads to maximum remuneration for the consumer.

### BRIEF DESCRIPTION OF DRAWINGS

FIG. 1 is a block diagram illustrating a first embodiment;

FIG. 2 is an explanatory view illustrating operation of the first embodiment; and

FIG. 3 is a block diagram illustrating a second embodiment.

### DESCRIPTION OF EMBODIMENTS

In each of embodiments described below, it is assumed that an aggregator pays remuneration to a plurality of consumers, the aggregator intermediating between a supplier and the plurality of consumers, the supplier supplying electric power to a plurality of target spaces managed by the plurality of consumers. The aggregator is a business operator which conducts business of adjusting a power demand, assisting in saving electric power, and the like by managing electric power in at least one consumer. In the following embodiments, the aggregator conducts business of adjusting a power demand, assisting in saving electric power, and the like by managing electric power in each of a plurality of consumers.

The consumer is a contractee which purchases electric power, and the target space is a place to which the electric power is supplied. The target space is a spatial area corresponding to an area above an electric path electrically connected to an electric power grid and means a spatial area, such as a detached house, a dwelling unit of a multiple residential dwelling complex, an office of an office building, or a shop of a commercial building, where consumed electric energy is measured by an electric power meter.

The aggregator receives a power saving request from the supplier to cause consumers which contract with the aggregator to save electric power. When electric power received by the consumers from the electric power grid satisfies prescribed conditions of the power saving request from the supplier, the aggregator receives remuneration from the supplier and distributes part of the remuneration to the consumers. That is, the aggregator receives the power saving request from the supplier to cause the consumers serving as clients to save electric power, and the aggregator pays the remuneration (incentive reward) according to electric energy corresponding to the electric power saved by the consumers, thereby assisting the supplier in achieving the power saving request. Moreover, the aggregator manages or assists in energy saving (electric power saving) of the plurality of consumers which contract with the aggregator.

The power saving request may set a limit value during a relatively long time period (for example, one month) or may specify a limit value during a specific short time period (for example, a time zone of a specific day). Thus, in the following description, a case where the consumers respond to the power saving request includes a case where the consumers continue saving electric power during a relatively long time period and a case where the consumers save electric power only during a specific short time period. The present embodiment is basically directed to the former case, but the technique described below is applicable also to the latter case.

Such an aggregator is sometimes referred to as a demand response (DR) aggregator. The aggregator is assumed to be a business operator targeting detached houses. However, the aggregator may be a building energy management system (BEMS) aggregator targeting buildings, an aggregator targeting multiple residential dwelling complexes, or the like.

The supplier may be a power generation wholesaler or a power retailer which purchases electric power from a power market to supply the electric power to consumers. In the following description, the aggregator assumes to be a business operator independent of the supplier, but the aggregator may also serve as the power retailer.

The aggregator does not provide the same service plans to the consumers in return for responses of the consumer to the power saving request, and even when a focus is given to only the aspect of remuneration to be received by the consumer, differences arise depending on conditions including time zones and electric energy. Alternatively, when a plurality of aggregators are available, different aggregators may provide different service plans. Thus, each consumer has to select a service plan when contracting with an aggregator. However, an increase in types of the service plan makes it difficult for each consumer to make a decision in selecting a service plan.

A contract assistance apparatus is configured, when a consumer selects one of service plans provided by the aggregators, to extract a service plan suitable for the consumer and to show the service plan to the consumer. A criterion used for determination by the contract assistance apparatus of each embodiment is remuneration for the consumers, and the contract assistance apparatus is configured to select a service plan which leads to maximum remuneration for each consumer.

### First Embodiment

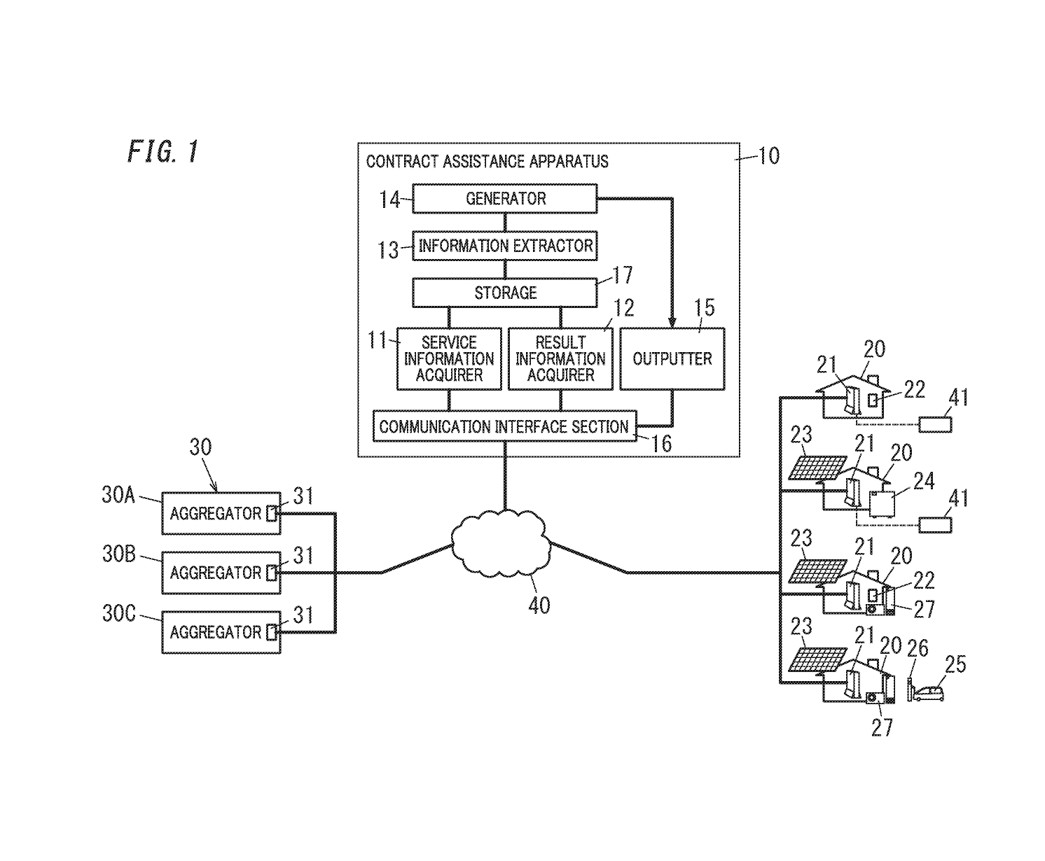

FIG. 1 schematically shows a configuration of a contract assistance system. The contract assistance system is configured such that a contract assistance apparatus 10, a plurality of (in FIG. 1, four) management apparatuses 21, and a plurality of (in FIG. 1, three) servers 31 communicate one another over an electric communication line 40. Each of the plurality of servers 31 is not an essential element for the contract assistance system. The plurality of servers 31 shown in FIG. 1 are disposed so that the contract assistance apparatus 10 acquires a plurality of service plans. Thus, when the contract assistance apparatus 10 does not acquire service plans through communication with the servers 31, the servers 31 may be omitted. Moreover, the number of the management apparatuses 21 is not necessarily two or more but may be only one. That is, minimum essential elements of the contract assistance system are the contract assistance apparatus 10 and at least one management apparatus 21, wherein the management apparatus 21 is only required to be configured to communicate with the contract assistance apparatus 10 and to transfer result information regarding power consumption in a target space 20 to the contract assistance apparatus 10.

As illustrated in FIG. 1, the contract assistance apparatus 10 has a function of communicating with the plurality of management apparatuses 21 installed in the plurality of (in FIG. 1, four) target spaces (for example, houses of the consumers) 20 and a function of communicating with the plurality of servers 31 managed by a plurality of aggregators 30. Each management apparatus 21 installed in a corresponding one of the target spaces 20 has a function of monitoring the transition of electric power in the target space 20. In the present embodiment, the management apparatus 21 is a controller establishing a home energy management system (HEMS) and is configured to acquire the transition of electric power in the target space 20 from a meter annexed to a distribution board. Service information regarding service plans provided by the aggregator 30 are registered in each server 31 managed by the aggregator 30.

In the target space 20, a load appliance 22 which consumes electric power is disposed. Moreover, in the target space 20, a power generating facility 23 configured to generate power by using natural energy (recyclable energy) may be disposed. Examples of the power generating facility 23 include a photovoltaic facility. Moreover, in the target space 20, at least one or more facilities may be selected from a battery facility 24, a charge/discharge facility 26 to which an electric vehicle 25 is to be connected, a storage tank water heater 27, a fuel cell system, and the like.

The power generating facility 23 is connected to an indoor wire so as to be linked with an electric power grid and can supply generated electric power to the load appliance 22. The battery facility 24 is connected to an indoor wire and is configured to switch between a state of accumulating electric power from the electric power grid or the power generating facility 23 and a state of feeding the accumulated electric power to the load appliance 22. The charge/discharge facility 26 has a function of charging a storage battery mounted on the electric vehicle 25 and a function of discharging the storage battery. The charge/discharge facility 26 can supply electric power to the load appliance 22 similarly to the battery facility 24 while the electric vehicle 25 is connected to the charge/discharge facility 26. The fuel cell system is a type of a cogeneration facility, has a function of boiling water simultaneously with generation of electric power, and can supply the generated electric power to the load appliance 22. Moreover, heat generated during the generation of the electric power is accumulated as hot water in a hot water storage tank. Similarly to the fuel cell system, the heat pump water heater 27 can accumulate heat corresponding to used electric power as hot water in a hot water storage tank.

The management apparatus 21 basically stores transition of electric power received in the target space 20 from the electric power grid. The transition of electric power stored in the management apparatus 21 is transition of the average value (the power value of a unit time) of electric power in a unit time selected from, for example, about 1 second to 30 minutes. For example, when one minute is defined as the unit time, the management apparatus 21 uses a value obtained by dividing electric energy of one minutes by 60 as the power value (power value of unit time) of the one minute. Moreover, the management apparatus 21 may use electric energy of one minute as it is as the power value of the unit time to indicate transition of electric power.

When facilities as described above are disposed in the target space 20, the management apparatus 21 stores the transition of electric power received in the target space 20 from the electric power grid in association with operation of the facilities. The management apparatus 21 can communicate with the plurality of servers 31 of the plurality of aggregators 30, and when the management apparatus 21 receives, for each of the plurality of aggregators 30, a power saving request from the aggregator 30 via the server 31, the management apparatus 21 also stores a result of a response to the power saving request. These pieces of information stored in the management apparatus 21 are the result information. The result information includes the transition of electric power received from the electric power grid and the result of a response to the power saving request. When the facilities described above are disposed in the target space 20, the result information also includes operation of the facilities.

Here, information based on which the aggregator 30 gives a power saving request to the consumers includes a period during which power saving is under demand and an upper limit value of electric power which the consumers can receive during the period. The upper limit value of the electric power may be given in one case as electric power (power value or electric energy) to be received by the consumers and in the other case as a proportion (for example, 80%) to electric power (power value or electric energy) expected to be consumed when the electric power is not saved. In both cases, the electric power expected to be consumed when the electric power is not saved is obtained.

Such electric power expected to be consumed when the electric power is not saved is referred to as “power demand forecast”. The power demand forecast is determined by using, for example, usage record of electric power in each target space 20 in the past or usage record of electric power in a plurality of target spaces 20 which are similar to the target space 20 which is a target in terms of the usage record of electric power.

As described above, the contract assistance apparatus 10 communicates with each management apparatus 21 and each server 31. A path of the communication is the electric communication line 40 such as the Internet or a mobile communication network, and communication data is encrypted. When communication is performed by using such an electric communication line 40, the contract assistance apparatus 10 is realizable in a server which performs communication through the electric communication line 40. The server in which the contract assistance apparatus 10 is realized may be a server using a single computer or a server including a plurality of computers, or may be a cloud computing system.

The contract assistance apparatus 10 includes a service information acquirer 11 and a result information acquirer 12. The service information acquirer 11 is configured to acquire the service information including a service plan from each server 31. The result information acquirer 12 is configured to acquire the result information regarding usage record of the electric power from the management apparatus 21. The contract assistance apparatus 10 further includes an information extractor 13 and a generator 14. The information extractor 13 is configured to extract a service plan to be recommended to a consumer from the plurality of service plans acquired from the plurality of servers 31. The generator 14 is configured to generate recommendation information to be provided to the consumer by using the service plan extracted by the information extractor 13.

The recommendation information generated by the generator 14 is output by an outputter 15 and is reported to the management apparatus 21 arranged in the target space 20. The contract assistance apparatus 10 includes a communication interface section 16 connected to the electric communication line 40. The service information acquirer 11 communicates with the server 31 through the communication interface section 16. The result information acquirer 12 and the outputter 15 communicate with the management apparatus 21 through the communication interface section 16.

When receiving the recommendation information, the management apparatus 21 notifies a terminal apparatus 41 of the content of the recommendation information. The terminal apparatus 41 may be a dedicated apparatus connected to the management apparatus 21 or a universal apparatus selected from a smartphone, a tablet terminal, a personal computer, and the like.

To perform notification of an example of service plans, it is assumed that a consumer may contract with three aggregators 30A, 30B, and 30C, and each of the three aggregators 30A, 30B, and 30C is supposed to provide one service plan. The service plan includes remuneration information regarding remuneration to be received by the consumer when each of the aggregators 30A, 30B, and 30C gives a power saving request to the consumer and the consumer accepts the power saving request.

The remuneration information of the service plans provided by the aggregators 30A, 30B, and 30C is represented as a combination of a time period and the remuneration as an example of Table 1. In the examples of Table 1, the time period is represented by a time zone in a day, and the remuneration is represented by a unit price. The service plan provided in such a format is fixed during a relatively long time period (selected from one month, three months, six months, one year, two years, and the like).

TABLE 1

| Aggregator | Time Zone | Unit Value [yen/kWh] |
|---|---|---|
| 30A | 5:30-6:30 17:30-18:30 | 10 |
| 30B | 6:30-7:30 16:30-17:30 | 15 |
| 30C | 11:00-13:00 | 30 |

The service plans may be different among the aggregators 30A, 30B, and 30C as shown in Table 1. The service information acquirer 11 communicates with the servers 31 managed by the aggregators 30A, 30B, and 30C to acquire the service information regarding the service plans and stores the service information including the remuneration information as illustrated in Table 1 in a storage 17. Note that the setting of the unit price in the service plan is supposed to be performed by the aggregator 30 on the basis of the “limit value LV” which will be described later, but the setting of the unit price is not limited to the above setting. For example, the aggregator 30 may independently set the unit price.

The result information acquirer 12 acquires result information of each target space 20 and stores the result information in the storage 17. The result information for a time period which lasts to such an extent that the power demand forecast can be obtained has to be stored in the storage 17. The storage 17 stores result information of, for example, one month.

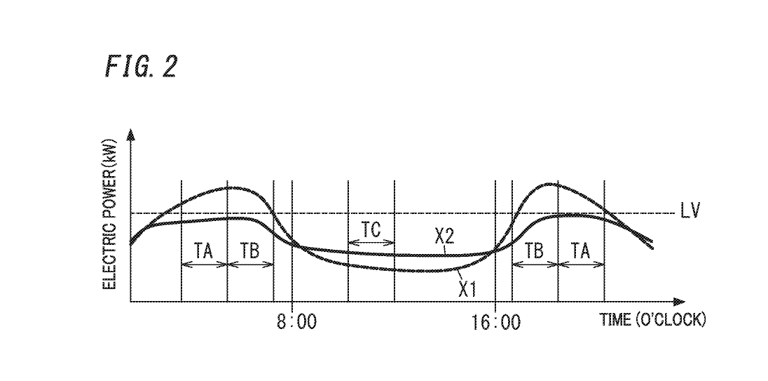

The information extractor 13 uses result information of one month of each target space 20 stored in the storage 17 to obtain transition of electric power of one day in the target space 20 as the power demand forecast. The broken line X1 of FIG. 2 shows an example of the power demand forecast. The power demand forecast (broken line X1) represents average transition of electric power of a day on which electric power is not saved. The electric power is electric power received in the target space 20 from the electric power grid. Note that as described above, the power demand forecast (broken line X1) may be obtained from the result information of each target space 20 or may be obtained from result information of the plurality of target spaces 20 whose transition of electric power is similar to each other.

The information extractor 13 not only obtains the power demand forecast (broken line X1) but also uses the result information of the target space 20 for the power saving request to calculate how the target space 20 responded to the power saving request and how much electric energy has been eventually reduced. The solid line X2 of FIG. 2 represents average transition of electric power of a day on which a response is given to the power saving request. Thus, electric energy corresponding to the area between the solid line X2 and the broken line X1 represents a decrement or an increment of electric energy with respect to the power demand forecast (broken line X1) when the response is given to the power saving request.

In the example shown in FIG. 2, to simplify the description, the time zone in which power saving is under demand is set to a whole day. This situation occurs not only during a time period during which an electric power demand increases with respect to power supply but also, for example, when the limit value LV is set for the value (which may be electric energy for every 30 minutes) of power consumable by the consumer under a negotiated contract between the supplier and the consumer. The amount of information regarding the result of a response to the power saving request may be small, but when the limit value LV is set, the transition of electric power of a case where electric power is saved to maintain the limit value LV can be relatively easily obtained by simulation.

When the time zone of each of the service plans shown in Table 1 is applied to FIG. 2, the aggregator 30A corresponds to a plurality of (in FIG. 2, two) time zones TA, the aggregator 30B corresponds to a plurality of (in FIG. 2, two) time zones TB, and the aggregator 30C corresponds to one time zone TC. That is, each time zone TA is a time zone of a service plan provided by the aggregator 30A, each time zone TB is a time zone of a service plan provided by the aggregator 30B, and the time zone TC is a time zone of a service plan provided by the aggregator 30C. Here, when the consumer responded to the power saving request, the electric energy reduced from the power demand forecast (broken line X1) in the target space 20 is assumed to be 60 kWh in total in the time zones TA and 90 kWh in total in the time zones TB. In the time zone TC, the electric power (solid line X2) which the target space 20 receives from the electric power grid is higher than the power demand forecast (broken line X1) but is lower than the limit value LV, and the time zone TC is a time zone having no connection with the power saving request, and therefore, the reduced electric energy is deemed to be 0 kWh.

The remuneration which the consumer is to receive is 600 yen (=10 yen×60 kWh) in total in the time zones TA, 1350 yen (=15 yen×90 kWh) in total in the time zones TB, and 0 yen (=30 yen×0 kWh) in the time zone TC. The information extractor 13 performs the calculation described above, and when the target space 20 has the characteristic shown in FIG. 2, the information extractor 13 determines that adopting the service plan provided by the aggregator 30B leads to better remuneration than adopting the service plans provided by the aggregators 30A and 30C.

The information extractor 13 uses the service information which has been acquired by the service information acquirer 11 and stored in the storage 17 and the result information which has been acquired by the result information acquirer 12 and stored in the storage 17 to calculate remuneration to be received by the consumer as described above. The information extractor 13 extracts, from the plurality of service plans, a service plan which leads to maximum remuneration to be received by the consumer. That is, the information extractor 13 extracts, on the basis of the result information, a service plan to be recommended to the consumer from the plurality of service plans. Note that in the above-described example, the time zones of the service plans provided by the aggregators 30A, 30B, and 30C do not overlap each other to simplify the description. However, also when the time zones of the service plans overlap each other, the information extractor 13 can extract a service plan which leads to maximum remuneration to be received by the consumer in the above-described procedure.

The information extractor 13 extracts a service plan which is estimated to lead to maximum remuneration to be received by the consumer. Then, the generator 14 generates recommendation information to be provided to the consumer by using the service plan which has been extracted. The recommendation information includes information such as the service plan extracted by the information extractor 13 and the aggregator 30 which provides the service plan. Moreover, to be able to explain a reason why the service plan included in the recommendation information is advantageous for the consumer to which the recommendation information is provided, the recommendation information preferably includes an estimated amount of the remuneration with reference to the result information in the past. Moreover, the recommendation information may include data for providing information similar to the transition of electric power shown in FIG. 2 to the consumer.

The recommendation information generated by the generator 14 is output through the outputter 15. The outputter 15 can transmit the recommendation information through the communication interface section 16 to the management apparatus 21 of the consumer. In this case, the management apparatus 21 notifies the terminal apparatus 41 of the content of the recommendation information. Moreover, the outputter 15 can transmit the recommendation information through the communication interface section 16 to a terminal apparatus which can access to the contract assistance apparatus 10 through the electric communication line 40. For example, the outputter 15 is configured to provide the recommendation information in Web page format and can provide the recommendation information after a check by the consumer to the terminal apparatus which accesses a Web page through the electric communication line 40.

The service plan has been described with reference to a service plan fixed for a long time period but may be a service plan considering seasonal variation. For example, the service plan may be a service plan in which the remuneration information changes in units of two weeks, one month, three months, or the like. Alternatively, the service plan may be a service plan in which weekdays and holidays are differentiated or a service plan in which days of the week are differentiated by taking the attributes of days into consideration.

When the aggregator 30 provides such a service plan, result information of a relatively long time period of the target space 20 is required for comparison with the usage record of electric power in the target space 20. Thus, the information extractor 13 may be configured to repeat selecting of a service plan suitable for the target space 20 during an arbitrary time period and to search for a service plan more suitable for the power usage in the target space 20.

Moreover, in the above-described configuration example, an example in which a plurality of service plans correspond to the plurality of aggregators 30A, 30B, 30C on a one-to-one basis has been described, but the single aggregator 30 may provide a plurality of service plans. The service plan does not have to be a plan relating to the unit price of each time zone but may be a plan relating to the amount of money paid to the consumer when the limit value is never exceeded during a prescribed time period (for example, one day). The remuneration does not have to be a unit price per electric energy but may be stepwise set for electric energy according to saved electric power.

Moreover, the result information acquirer 12 does not have to acquire the result information from the management apparatus 21 but may acquire transition of electric power of the result information by the value of an electric power meter which can output the transition of electric power. Examples of the electric power meter include a smart meter.

In the above-described configuration example, the information extractor 13 extracts only a service plan which leads to maximum remuneration for the consumer, but the recommendation information may include a service plan which leads to second maximum remuneration and a service plan which leads to third maximum remuneration in addition to the service plan which leads to the maximum remuneration. Proposing two or more service plans to the consumer enables the consumer to select, from the plurality of service plans provided to the consumer, a service plan according to the consumer's preference with reference to the two or more service plans selected by the contract assistance apparatus 10. For example, this enables the consumer to select a service plan with reference to the reliability degree or the like of the aggregator 30 evaluated by the consumer.

Since the contract assistance apparatus 10 selects a service plan to be recommended to the consumer and provides the recommendation information to the consumer, the consumer can know a service plan which possibly provides relatively high remuneration among the plurality of service plans provided by the aggregator. That is, the contract assistance apparatus 10 can assist the consumer in making a decision when the consumer contracts with the aggregator in terms of the service plan.

Moreover, since the contract assistance apparatus 10 selects the service plan on the basis of the result information in the target space 20, the consumer can respond to the power saving request without significantly changing the rhythm of life and can substantially reliably respond to the power saving request. Moreover, a possibility that the consumer responds to the power saving request as scheduled is increased, and therefore, it becomes possible for the aggregator 30 to limit the electric power to be supplied to the consumer so as not to exceed the limit value of the electric power defined in the contract with the supplier. That is, the aggregator 30 causes the consumer to save electric power, thereby reliably receive remuneration from the supplier, and the aggregator 30 can distribute the remuneration to consumers depending on service plans.

The above-described configuration example is directed to a case where only the load appliance 22 which consumes electric power is disposed in the target space 20. Thus, the result of responses to the power saving request in the target space 20 is used to select a service plan to be recommended to a consumer. Meanwhile, the consumer is caused to adjust electric power such that electric power supplied from the supplier to the electric power grid is levelled during a prescribed time period (for example, one day) without responding to the power saving request, which enables the electric power supplied to the electric power grid to be maintained at a value lower than or equal to the limit value.

For example, when a facility configured to supply electric power is disposed in the target space 20, such a facility supplies electric power during a time period during which electric power to be received in the target space 20 from the electric power grid is expected to exceed the limit value, which enables the electric power to be received from the supplier to be maintained at a value lower than or equal to the limit value. The facility configured to supply electric power is at least one facility selected from the power generating facility 23, the battery facility 24, the charge/discharge facility 26, a fuel cell system, and the like. Supplying electric power from such a facility reduces electric energy which the target space 20 receives from the electric power grid, and electric power to be supplied from the supplier to the electric power grid eventually decreases. The facility configured to supply electric power may be a facility which enables electric power to reversely flow to the electric power grid. When the electric power reversely flows to the electric power grid, electric power to be supplied from the supplier to the electric power grid decreases. The facility configured to reduce electric power supplied from the supplier to the electric power grid is accordingly operated to enable leveling of the electric power to be supplied from the supplier to the electric power grid during the prescribed time period. As a result, it becomes possible to suppress the total electric power to be supplied from the supplier to the electric power grid to be lower than or equal to the limit value.

Moreover, when a facility, such as a storage tank water heater 27 in which a time period for using thermal energy may be shifted with respect to a time period for consuming electric power, is disposed in the target space 20, it is possible to adjust a time period during which such a facility receives electric power from the electric power grid. That is, using such a facility to adjust the time period for receiving electric power from the electric power grid enables the total electric power supplied from the supplier to the electric power grid to be maintained at a value lower than or equal to the limit value.

In the above-described configuration example, the power demand forecast is determined on the basis of electric energy received from the electric power grid during a time period during which electric power is not saved in the target space 20. When a facility such as the power generating facility 23, the battery facility 24, the fuel cell system, or the like configured to supply electric power is disposed in the target space 20, the facility can supply electric power to the load appliance 22 so as not to vary the electric power consumed in the target space 20. In this case, the power demand forecast (broken line X1) may be obtained on the basis of the electric power consumed in the target space 20.

As described above, the contract assistance apparatus 10 of the present embodiment acquires service information including a plurality of service plans from one or more aggregators 30 (any of the plurality of aggregators 30A, 30B, 30C) and acquires result information from the management apparatus 21 in the target space 20. Any of the service information and the result information may be acquired first. The service information and the result information are stored in the storage 17. The information extractor 13 analyzes the result information stored in the storage 17 and uses the plurality of service plans included in the service information to calculate remuneration to be received by the consumer for each of the plurality of service plans. Then, the information extractor 13 extracts, from the plurality of service plans, the service plan leading to a maximum one of the remunerations which have been calculated. The generator 14 generates, on the basis of the service plan, recommendation information for the consumer and outputs the recommendation information through the outputter 15.

In sum, on the basis of the result information regarding power consumption in the target space 20 to which the electric power is supplied, the information extractor 13 extracts a service plan to be recommended to the consumer from the plurality of service plans to be provided to the consumer of electric power. Next, the generator 14 uses the service plan extracted by the information extractor 13 to generate recommendation information to be provided to the consumer. Each of the plurality of service plans includes remuneration information regarding remuneration to be received by the consumer when the consumer reduces the amount of received power in the target space 20 from the electric power grid. The information extractor 13 extracts, from the plurality of service plans, a service plan which leads to maximum remuneration for the consumer.

The contract assistance apparatus 10 of the present embodiment described above includes the service information acquirer 11, the result information acquirer 12, the information extractor 13, the generator 14, and the outputter 15. The service information acquirer 11 acquires the plurality of service plans to be provided to the consumer of electric power. Each of the plurality of service plans includes the remuneration information regarding remuneration to be received by the consumer when the consumer reduces the amount of received power in the target space 20 from the electric power grid. The result information acquirer 12 acquires the result information regarding the power consumption in the target space 20 to which electric power is supplied. The information extractor 13 extracts, on the basis of the result information, the service plan to be recommended to the consumer from the plurality of service plans. That is, the information extractor 13 extracts, from the plurality of service plans, the service plan which leads to maximum remuneration for the consumer. The generator 14 uses the service plan extracted by the information extractor 13 to generate the recommendation information to be provided to the consumer. The outputter 15 outputs the recommendation information generated by the generator 14.

With this configuration, when the consumer selects a service plan, the consumer is notified of the service plan which leads to the maximum remuneration for the consumer as the recommendation information, and therefore, it becomes possible to assist the consumer in making a decision in selecting the service plan.

The plurality of service plans are provided by the aggregator which intermediates between the consumer and the supplier who supplies electric power to the consumer. The remuneration is provided to the consumer when the consumer responds to the power saving request. The result information includes the transition of electric power received from the electric power grid when electric power is not saved in the target space 20 and the transition of electric power received from the electric power grid when electric power is saved in the target space 20 in response to the power saving request.

Thus, on the basis of the result in the case of the consumer responding to the power saving request, the service plan is selected such that the remuneration is maximum when the consumer saves electric power, and the consumer is only required to act similarly to the case where the consumer responded to the power saving request in the past, which leads to increased benefit. Moreover, since the probability that the consumer accepts the power saving request increases, it becomes easy for the supplier to achieve a goal of the electric power saving.

Moreover, each of the plurality of service plans preferably includes the information in which the remuneration and the time zone are combined with each other. When each service plan includes remuneration of each time zone, the information extractor 13 can select the service plan so that it matches the time zone in which the consumer easily responds to the power saving request.

### Second Embodiment

In the first embodiment, the remuneration to be received by the consumer when electric power is saved in the target space 20 depends on the remuneration information set by the aggregator 30. In contrast, a fee paid by the consumer for electric energy received in the target space 20 from the electric power grid depends on an electricity price set by the supplier. In the above-described example, a proposal considering only a service plan is provided by the aggregator 30 to maximize the remuneration to be received by the consumer. In contrast, to reduce the fee paid by the consumer and to increase the remuneration to be received by the consumer, the generator 14 may made a proposal by combining the electricity price of the supplier and the service plan of the aggregator 30.

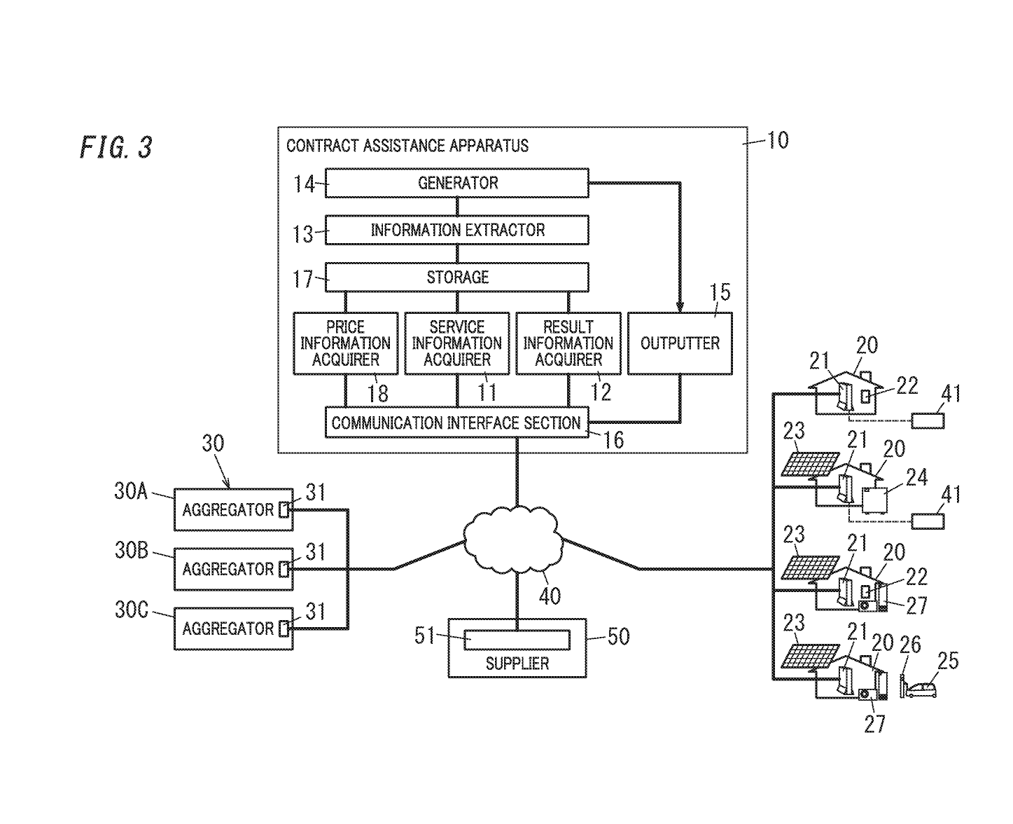

That is, a contract assistance apparatus 10 shown in FIG. 3 has the configuration of the contract assistance apparatus 10 of the first embodiment shown in FIG. 1 and further includes a price information acquirer 18 configured to acquire price information of electric power. The price information is information regarding the price of electric power to be received in a target space 20 from an electric power grid. The price information acquirer 18 has a function of communicating with a server 51 managed by a supplier 50 and acquires the price information from the server 51. As the price information, the supplier 50 provides a plurality of types of charge plans based on, for example, electric energy to be consumed by the consumer or the type of a load appliance 22 to be used by the consumer during a prescribed time period. For example, a charge plan in which the unit price of the electricity price is different in each of time zones in a day, a charge plan in which the unit price of the electricity price stepwise changes for electric energy used for one month, or the like is available.

Here, the supplier 50 may contracts with a plurality of aggregators 30, and the aggregator 30 does not necessarily contract with one supplier 50 but may contract with a plurality of suppliers 50. The above-described configuration example assists a consumer in selecting an aggregator 30, but when the consumer may select any of a plurality of suppliers 50, it is preferred to be able also to assist in selecting a supplier 50.

A decision in selecting a supplier 50 is made on the basis of whether or not benefit for the consumer is increased in a similar manner to the selection of the aggregator 30. In general, in the relationship between the consumer and the supplier 50, it can be said that the benefit for the consumer is greater when the electricity price to be paid to the supplier 50 in accordance with the electric energy received in the target space 20 from the electric power grid is lower. When a power generating facility which enables electric power to reversely flow to the electric power grid is disposed in the target space 20, a remuneration amount (a so-called sellable power price) for electric energy which reversely flows is also benefit for the consumer.

In the contract assistance apparatus 10 shown in FIG. 3, the information extractor 13 not only extracts, from the plurality of service plans, a service plan which leads to maximum remuneration for the consumer but also selects, from the plurality of suppliers 50, a supplier 50 which leads to maximum benefit for the consumer. That is, for a consumer who has no facility configured to generate sellable electric power, the information extractor 13 selects, from a plurality of charge plans (a plurality of suppliers 50), a charge plan (a supplier 50) which leads to the minimum electricity price to be paid. Moreover, for a consumer who has a facility configured to generate sellable electric power, the information extractor 13 selects, from the plurality of suppliers 50, a supplier 50 which leads to the maximum benefit, where the benefit is the amount of difference between remuneration (gain) received in return for selling electric power and the electricity price (expenditure) to be paid. The other configurations and operation of the contract assistance apparatus 10 shown in FIG. 3 are similar to the configuration and operation of the first embodiment shown in FIG. 1.

The contract assistance apparatus 10 may include a price information acquirer 18 configured to acquire a plurality of charge plans regarding a price of electric power to be received by the consumer from the electric power grid. In this case, based on the result information, the information extractor 13 extracts, from the plurality of charge plans, a charge plan which leads to the minimum amount of payment of the consumer. Moreover, the generator 14 preferably incorporates the charge plan extracted by the information extractor 13 into the recommendation information.

This configuration generates the recommendation information so as to reduce the electricity price to be paid by the consumer to the supplier. Thus, the recommendation information is proposed to the consumer so that the remuneration for the electric power saving is maximum and the electricity price is minimum. In other words, a combination of the supplier 50 and the aggregator 30 is proposed to achieve the maximum benefit for the consumer, thereby assisting the consumer in making a decision when the consumer contracts with the supplier 50 and the aggregator 30.

The above-described contract assistance apparatus 10 includes a device including a processor configured to execute a program, a device for an interface configured to transmit and receive data to and from other apparatuses, and a storage device for storing the data as main components. That is, the contract assistance apparatus 10 executes a program by a computer to realize the above-described functions. As the storage device, a storage apparatus such as semiconductor memory having a short access time and a storage apparatus such as a hard disk apparatus having a large capacity are used in combination. The device including a processor may be micro processing unit (MPU) separated from the semiconductor memory or may be a microcontroller integrally including the semiconductor memory.

The program which causes the computer to function as the contract assistance apparatus 10 may be provided in a state where the program is written in read only memory (ROM) or may be provided in a state where the program is written in a recording medium such as an optical disk. Alternatively, the program may be provided through an electric communication line such as the Internet, and the program may be written in the semiconductor memory included in the contract assistance apparatus 10.

The function of the contract assistance apparatus 10 is not limited to selecting, for each of the plurality of consumers, the service plan which leads to the maximum remuneration for the consumer from the plurality of service plans to be provided to the consumer. The contract assistance apparatus 10 may select, for only one consumer, a service plan which leads to maximum remuneration for the consumer from the plurality of service plans to be provided to the consumer.

Note that the above-described embodiments are mere examples of the present invention. Thus, the present invention is not limited to the above-described embodiments, and even in embodiments other than these embodiments, various modifications may be made depending on design and the like without departing from the technical idea of the present invention.

### REFERENCE SIGNS LIST

10 Contract Assistance Apparatus

11 Service Information Acquirer

12 Result information Acquirer

13 Information Extractor

14 Generator

15 Outputter

18 Price Information Acquirer

20 Target Space

1. A contract assistance apparatus, comprising:
a service information acquirer configured to acquire a plurality of service plans to be provided to a consumer who consumes electric power;
a result information acquirer configured to acquire result information regarding electric power consumption in a target space to which electric power is supplied;
an information extractor configured to extract, from the plurality of service plans, a service plan to be recommended to the consumer based on the result information;
a generator configured to use the service plan extracted by the information extractor to generate recommendation information to be provided to the consumer; and
an outputter configured to output the recommendation information generated by the generator, wherein
each of the plurality of service plans includes remuneration infoiiiiation regarding remuneration to be received by the consumer when the consumer reduces an amount of received electric power in the target space from an electric power grid, and
the information extractor extracts, from the plurality of service plans, a service plan which leads to maximum remuneration for the consumer.

2. The contract assistance apparatus according to claim 1, wherein
the plurality of service plans are provided by an aggregator which intermediates between the consumer and a supplier who supplies electric power to the consumer,
the remuneration is provided to the consumer when the consumer responds to a power saving request, and
the result information includes
transition of electric power received from the electric power grid when electric power is not saved in the target space, and
transition of electric power received from the electric power grid when electric power is saved in the target space in response to the power saving request.

3. The contract assistance apparatus according to claim 1, wherein
each of the plurality of service plans includes information in which the remuneration and a time zone are combined with each other.

4. The contract assistance apparatus according to claim 1, further comprising a price information acquirer configured to acquire a plurality of charge plans regarding a price of electric power to be received by the consumer from the electric power grid, wherein
based on the result information, the information extractor extracts, from the plurality of charge plans, a charge plan which leads to a minimum amount of payment of the consumer, and
the generator incorporates the charge plan extracted by the information extractor into the recommendation information.

5. A contract assistance system, comprising:
the contract assistance apparatus according to claim 1; and
a management apparatus configured to communicate with the contract assistance apparatus and to transfer the result information regarding electric power consumption in the target space to the contract assistance apparatus.

6. A contract assistance method, comprising:
selecting from a plurality of service plans to be provided to a consumer of electric power, a service plan to be recommended to the consumer by an information extractor based on result information regarding power consumption in a target space to which electric power is supplied; and
generating by using the service plan selected by the information extractor, recommendation information to be provided to the consumer by a generator, wherein
the plurality of service plans include remuneration information regarding remuneration to be received by the consumer when the consumer reduces an amount of received power in the target space from an electric power grid, and
the information extractor extracts, from the plurality of service plans, a service plan which leads to maximum remuneration for the consumer.

7. The contract assistance apparatus according to claim 2, wherein
each of the plurality of service plans includes information in which the remuneration and a time zone are combined with each other.

8. The contract assistance apparatus according to claim 2, further comprising a price information acquirer configured to acquire a plurality of charge plans regarding a price of electric power to be received by the consumer from the electric power grid, wherein
based on the result information, the information extractor extracts, from the plurality of charge plans, a charge plan which leads to a minimum amount of payment of the consumer, and
the generator incorporates the charge plan extracted by the information extractor into the recommendation information.

9. The contract assistance apparatus according to claim 3, further comprising a price information acquirer configured to acquire a plurality of charge plans regarding a price of electric power to be received by the consumer from the electric power grid, wherein
based on the result information, the infom ation extractor extracts, from the plurality of charge plans, a charge plan which leads to a minimum amount of payment of the consumer, and
the generator incorporates the charge plan extracted by the information extractor into the recommendation information.

10. The contract assistance apparatus according to claim 7, further comprising a price information acquirer configured to acquire a plurality of charge plans regarding a price of electric power to be received by the consumer from the electric power grid, wherein
based on the result information, the information extractor extracts, from the plurality of charge plans, a charge plan which leads to a minimum amount of payment of the consumer, and
the generator incorporates the charge plan extracted by the information extractor into the recommendation infouiiation.

11. A contract assistance system, comprising:
the contract assistance apparatus according to claim 2; and
a management apparatus configured to communicate with the contract assistance apparatus and to transfer the result information regarding electric power consumption in the target space to the contract assistance apparatus.

12. A contract assistance system, comprising:
the contract assistance apparatus according to claim 3; and
a management apparatus configured to communicate with the contract assistance apparatus and to transfer the result information regarding electric power consumption in the target space to the contract assistance apparatus.

13. A contract assistance system, comprising:
the contract assistance apparatus according to claim 4; and
a management apparatus configured to communicate with the contract assistance apparatus and to transfer the result information regarding electric power consumption in the target space to the contract assistance apparatus.

14. A contract assistance system, comprising:
the contract assistance apparatus according to claim 7; and
a management apparatus configured to communicate with the contract assistance apparatus and to transfer the result inforrrration regarding electric power consumption in the target space to the contract assistance apparatus.

15. A contract assistance system, comprising:
the contract assistance apparatus according to claim 8; and
a management apparatus configured to communicate with the contract assistance apparatus and to transfer the result information regarding electric power consumption in the target space to the contract assistance apparatus.

16. A contract assistance system, comprising:
the contract assistance apparatus according to claim 9; and
a management apparatus configured to communicate with the contract assistance apparatus and to transfer the result information regarding electric power consumption in the target space to the contract assistance apparatus.

17. A contract assistance system, comprising:
the contract assistance apparatus according to claim 10; and
a management apparatus configured to communicate with the contract assistance apparatus and to transfer the result infoiination regarding electric power consumption in the target space to the contract assistance apparatus.
